(19) United States
(12) Patent Application Publication
(10) Pub. No.: US 2003/0230699 A1
(43) Pub. Date: Dec. 18, 2003

(54) Computer tower stand

(76) Inventor: David S. George, Marietta, OH (US)

Correspondence Address: KRAMER & AMADO, P.C., 2001 JEFFERSON DAVIS HWY, SUITE 1101, ARLINGTON, VA, 22202, US

(21) Appl. No.: 10/170,505

(22) Filed: Jun. 14, 2002

(51) Int. Cl. F16M 1/00; F16M 3/00; F16M 5/00

(52) U.S. Cl. 248/676

(57) ABSTRACT

A computer tower stand includes a structure including a shelf adapted to support a computer tower chassis, and a main compartment configured to conceal and store peripheral computer devices such as cables that extend from the computer tower chassis and various other electrical devices utilized in conjunction with the computer system. A speaker compartment is formed in the main compartment and configured to house and support a speaker assembly.

### BACKGROUND OF THE INVENTION

1. Field of the Invention

This invention relates generally to a personal computer support device, and specifically to a structure utilized to support a computer device and conceal electrical cords and peripheral devices utilized in conjunction with the computer device.

2. Discussion of Background

Computer owners have long been burdened by electrical cords, power outlet strips, surge protectors, AC adaptors, and other peripheral electrical devices that are utilized in conjunction with computer systems and that often create an unmanageable work space and unsightly and dangerous work environment. Typically, these peripheral devices include a variety of power and data cables and cords associated therewith to provide electrical signals to the device and connect the devices to the computer itself and an AC power outlet.

Desk top computer users, that utilize a computer tower chassis to house the computer, typically support the computer tower chassis on the floor or some other suitable flat surface that is disposed near the desk or other work space that the user is utilizing. The distance from the computer tower chassis to the associated peripheral electrical devices, such as a printer, a speaker(s), a monitor, a keyboard, and a mouse, is relative to the length of the power cable associated with the peripheral device and the distance from the device to the computer tower chassis and the AC electrical outlet. As a result of these constrictions, it is a common sight to see a plurality of electrical cords and cables disposed beside and extending from the computer tower. These electrical cords present an unsightly, distracting, and even dangerous environment to the computer user, a passerby, and to the computer system itself. Due to the proximity of the computer tower to the workspace of the user, the user or a passerby may trip over the electrical cords and cause injury to himself and/or the computer equipment. Furthermore, due to the sheer number of electrical cords utilized, it is common for these electrical cords to become tangled and twisted during the normal operation of the computer system. In this manner, manipulating the mouse or moving the keyboard, monitor, or some other peripheral device may cause one or more cords to pull on the adjacent cords such that one or more of the cords or devices become disconnected and/or damaged.

Furthermore, many conventional desktop computer systems utilize a variety of peripheral devices that afford the computer system multimedia capabilities. These peripheral devices often include one or two speakers that sit on a computer user's work surface, or some other surface adjacent to the user, to provide sound associated with a computer file being utilized. The speaker is provided with an electrical power cord that is connected to the computer tower chassis. Therefore, the additional power cords and associated speakers will also contribute to the unsightly pile of cords and devices utilized in conjunction with a conventional desktop computer system.

Therefore, there is a need for a device that supports a computer tower, for a computer system wherein the monitor and keyboard are separate from the computer, in a manner such that electrical peripheral devices and the excess length of electrical cords, that extend from the computer tower and the peripheral devices, may be both stored and concealed within the device while creating a safe working environment for the computer system, a user, and the general public.

### SUMMARY

It is an object of the present invention to provide a support device for a computer tower associated with a computer system, and conceal the electrical peripheral devices and the excess electrical cord length associated with the computer system.

The computer tower stand comprises a structure including a shelf adapted to support a computer tower chassis, and a main compartment configured to conceal and store peripheral devices such as cables that extend from the computer tower chassis and the various other electrical devices utilized in conjunction with the computer system. The main compartment is also configured to contain a compartment that supports a speaker assembly.

### BRIEF DESCRIPTION OF THE DRAWINGS

FIG. 1 is a front end perspective view of the computer tower stand supporting a computer tower chassis.

FIG. 2 is a front-end perspective view of the computer stand.

FIG. 3 is a side perspective view of the computer tower stand showing the wire and cable connections from the computer to various electrical devices stored within the computer tower stand and the interior of the computer tower stand.

FIG. 4 is a perspective view of another embodiment of the computer tower stand.

FIG. 5 is a perspective view of still another embodiment of the computer tower stand.

FIG. 6 is a perspective view of a computer system utilizing a work environment enhancer cable.

### BRIEF DESCRIPTION OF THE DRAWINGS

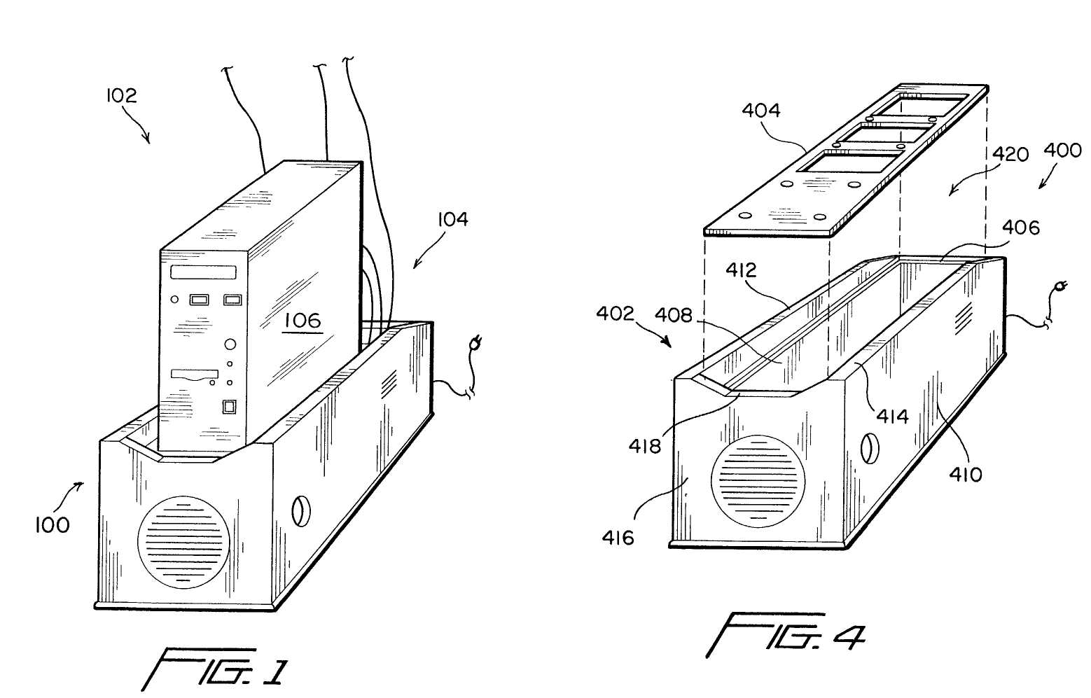

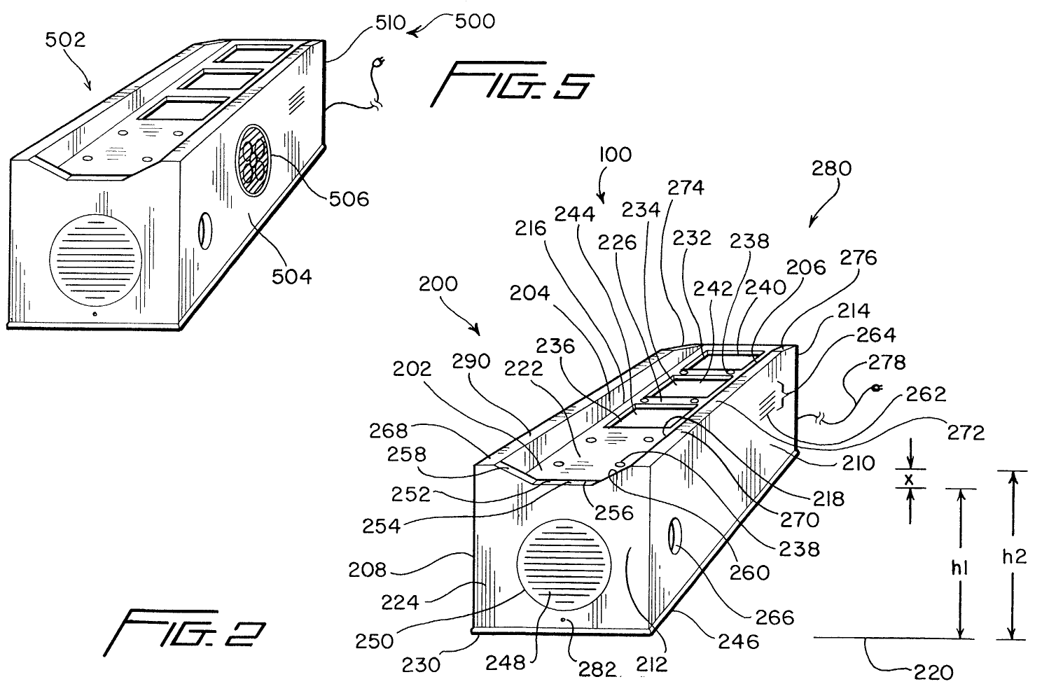

Referring to FIG. 1, the present invention provides for a system for supporting a computer tower chassis and other electrical equipment including computer peripheral devices that are apart of a conventional desk top computer system wherein the computer tower chassis is configured to be separated from a computer monitor and keyboard. In such a conventional system, the computer tower chassis is configured to be supported by a floor or some other appropriate surface such that the monitor, keyboard, and other peripheral devices may be connected to the computer tower chassis by their respective electrical cords or cables. FIG. 1 shows a computer tower stand 100 supporting a computer tower chassis 102 that houses a computer 106, of a desk top computer system, in an effort to facilitate the concealment of the excess length of cords 104, and other electrical equipment (see FIG. 3) stored within the interior of the computer tower stand 100.

Referring to FIGS. 1 and 2, computer tower stand 100 includes a housing 200 that comprises a shelf 202, a first side rail 204, a second side rail 206, a first side wall 208, a second side wall 210, a front wall 212, a back wall 214, a bottom wall 246, and a main compartment 300, discussed in detail below, formed therein. Housing 200 is structurally configured to supportively support any conventional computer tower chassis and store various other equipment therein, as will be discussed in greater detail below. Housing 200 may be made out of a metal, wood, plastic or other material that has the capabilities and properties to effect the intended purpose of the present invention.

As illustrated in FIG. 2, shelf 202 extends a vertical height h1 from a supporting surface 220 and connects front wall 212 to back wall 214, and side walls 208 and 210 at junctions 216, and 218, respectively, formed between side walls 208 and 210 and side rails 204 and 206. Shelf 202 includes a front portion 222 that is formed on a proximal side 224 of housing 200, and a distal portion 226 that extends from front portion 222 to back wall 214. A first opening 232 is formed adjacent on distal portion 236, a third opening 236 formed adjacent front portion 222 of shelf 202, and a second opening 234 is formed between first opening 232 and third opening 236. Vibratory discs 238 are disposed on front portion 222, and distal portion 226, between first, second, and third openings 232, 234, 236, and are configured to both dampen vibrations caused by electrical equipment stored in the computer tower stand 100 and shield computer chassis 102 from other forces that may act upon the same. Vibratory discs 238 also create a surface between computer chassis 102 and tower stand 100 in an effort to reduce wear and tear that may occur to housing 200 during normal operating conditions of the present invention. Vibratory discs 238 may be made of neoprene, felt, or any material that processes properties to effect the aforementioned intended purpose.

First, second, and third openings 232, 234, 236, form first, second, and third passageways 240, 242, and 244, respectively, that communicate with main compartment 300. First opening 232 has a sufficient width and length that afford sufficient space therein to pass electrical cords 104 into and out of main compartment 300, and facilitates the placement of various peripheral and electrical devices in main compartment 300 in a manner such that these devices may be passed through first passageway 240 and permanently positioned in main compartment 300. In an effort to supply electrical power to computer chassis 102 and various peripheral and electrical devices associated with a computer system, first opening 232 is formed in spatial relation to various electrical equipment and devices stored in main compartment 300 in a manner such that power may be afforded to computer chassis 102 and the various peripheral devices.

As illustrated in FIG. 2, second and third openings 234 and 236 are formed in proximal relation to first opening 232 and, similarly, have sufficient widths and lengths to facilitate the permanent placement of various peripheral and electrical devices within main compartment 300. In this manner, electrical equipment may be passed through passageways 242 and 244 in a manner such the devices may be placed in their permanent positions disposed in main compartment 300. The peripheral and electrical devices will be discussed in greater detail below.

Front wall 212 forms the front of housing 200 and has a plurality of slits 248 formed therein, the slits cooperating to form a speaker grille 250 configured to pass sound originating from a speaker assembly 330 (see FIG. 3) disposed behind speaker grille 250. A stop 252 extends from front wall 212 in an upwardly vertical direction. Stop 252 includes a ledge 254, that has a central section 256 that extends a distance x in an upwardly vertical direction from shelf 202 and is parallel to supporting surface 220, and two lateral sections 258 and 260 that extend from central section 256 and slope in an upwardly direction to height h2.

Sidewalls 208 and 210 connect front wall 212 to back wall 214 and bottom wall 246. Formed in sidewall 210 is a plurality of slits 262, that cooperate to form vent 264 to provide air to main compartment 300 and provide an exit for heat to ventilate through, and a sound port 266 used in conjunction with speaker assembly 330 (see FIG. 3). Similarly, sidewall 208 may include a sound port and ventilation assembly (not shown). Side rails 204 and 206 extend in an upwardly vertical direction from sidewalls 208 and 210, respectively. Side rails 204 and 206 each include ledges 268 and 270, respectively, that include running portions 270, 272 and sloping portions 274, 276, respectively. Side rails 204 and 206 cooperate with stop 252 and shelf 202 to form a supporting cavity 280 wherein computer tower chassis 102 is disposed when supported by stand 100.

Back wall 214 (not shown) has an opening for a conventional power cord 278 that is configured to connect to a standard wall outlet to provide electrical power to the devices stored within main compartment 300. A power status LED 282 may be disposed in front wall 212 to indicate whether an electrical component, such as speaker 330 (see FIG. 3), is on or off. Additionally, one or more ventilation assemblies and an opening through which a user may manipulate a power on/off switch, to control the components connected to an electrical device, may be formed in back wall 214.

Referring to FIGS. 1-3, the interior of main compartment 300 is configured to conceal the excess length of electrical cords 104 and store a plurality of electrical devices therein. The electrical devices may include a power supply, a surge protector and/or power strip 312, AC adaptors 314 and 326, a plurality electrical plugs 316, 318 for an external device, a bulky computer peripheral device 320 that may be utilized with the present invention, and a surge protector 322 that provides cable or phone line surge protection. For example, the bulky device 320 that may be stored within main compartment 300 may include extensions for mouse or keyboard cables, excess cable(s), AC adapters, secondary surge protectors, a power conditioner, a battery powered back-up power supply, external modems, fan assemblies, network input plugs, etc. The list is merely exemplary and not intended to be exhaustive. Surge protector 312 includes power cord 278 that extends from an opening (not shown) formed in back wall 214 such that the electrical devices, including computer 106, may be afforded power through one connection between power cord 278 and a standard wall outlet. In this manner, an on/off switch 324 may be used to provide or terminate power to the electrical devices connected to surge protector 312.

Electrical cords 104 may include a power cord 302 for a peripheral device, such as a scanner, monitor, or a printer (not shown), a cable or phone line cord 304 after passing through an electrical device, such as a surge protector 322 stored in main compartment 300, a cable 306 that connects the computer 106 to a peripheral device, a power cord 308 for the computer 106, and cable or phone line cord 310 extending from a line in the wall (not shown) and connecting to electrical device 322. Although a few electrical cords and cables that may be associated with a computer are identified, this list is not exhaustive. For example, a plurality of computer peripheral devices that may be used in conjunction with computer 106 may include various electrical cords that may benefit from the present invention.

As illustrated in FIGS. 1-3, computer tower stand 100 is utilized to store excess electrical cord and cable length that extends from computer tower chassis 102 and various other computer peripheral devices in an effort to create an organized arrangement of computer accessories and cables while minimizing unsightly, distracting, and dangerous computer systems that may result from a tangle of cords sitting beside a computer tower. To effect this purpose, computer tower stand 100 is configured to store and prevent excess cable length from engaging supporting surface 220. As seen in FIG. 3, a portion of the electrical cords 104, such as cable computer power cable 308, extend from the computer tower chassis, through first opening 232 and first passageway 240, and into main compartment 300 to power the computer devices, via AC adaptor 326 and surge protector 312. A portion of the electrical cords 104 associated with various peripheral devices, such as cable 302 used to power a monitor or printer, extend into main compartment 300 and plug into surge protector 312 to provide power and surge protection to the associated device. Furthermore, a portion of the cables 104 associated with external devices, such as cable or phone line cord 310 and 304, extend from an outlet disposed in a wall (not shown) into main compartment 300, via passageway 240, connect to surge protector 322 stored within main compartment 300, and pass through passageway 240 as they extend out main compartment 300 to form a connection to the associated device such as computer 106. Still Further, a portion of the cables 104 associated with peripheral devices, such as cable 328 that is utilized to transmit electrical signals to peripheral device 320, extend from a source external to computer tower stand 100 into main compartment 300, via passageway 240, connect to peripheral device 320, and extend out of main compartment to form a connection with computer 106. In this manner, computer tower stand 100 raises the computer 106 above supporting surface 220 and stores the excess length of associated electrical cables 104 to effectively prevent the entanglement of cords 104, and prevent the excess length of cables 104 from engaging supporting surface 220. Therefore, an unsightly and dangerous environment wherein the cords may cause a passerby to trip, the cords are removed upon accidental engagement with the same and an individual, or the cords are inadvertently disconnected from their associated electrical devices upon direct manipulation of adjacent cords and cables, is prevented.

Computer tower stand 100 may also be utilized to encase a speaker assembly 330. As illustrated in FIG. 3, a speaker compartment 332 is formed within main compartment 300 via a separation wall 334. Speaker assembly 330 is mounted by conventional means to a back surface 338 of front wall 214 such that the sound produced therefrom may travel through speaker grille 250 formed in front wall 214 and disposed adjacent to speaker 330 (see FIG. 2). Speaker assembly 330 has an electrical power cable (not shown) that extends through speaker compartment 332 and through main compartment 300 to connect to computer 106, via passageway 204. Speaker 330 may be a subwoofer assembly or any speaker that may be electrically connected a computer system and housed within a similar compartment. Sound port 266 is formed in sidewall 210 and speaker compartment 332. Although a preferred embodiment of speaker assembly 330 is illustrated herein, it is to be understood that variations may be made by one skilled in the art without departing from the scope and spirit of the present invention. For example, speaker assembly 330 may be a compact speaker assembly having a size and dimension to enable the same to fit within speaker compartment 332. Furthermore, there may be multiple speaker compartments that house one or more speaker assemblies.

In a first embodiment, computer tower stand 100 is constructed in a manner such that shelf 202 is integral with housing 200. As illustrated in FIG. 4, another embodiment of a computer tower stand 400 is shown wherein a housing 402 may be constructed such that a shelf 404 may be detached from housing 402 to facilitate the placement of electrical devices that are to be stored within a main compartment 420 of housing 402. Referring to FIG. 4, a ledge 406 is formed around the inside periphery of housing 402 at a junction between a pair of opposing side walls 408, and 410 and front wall 416, and a pair of opposing side rails 412, and 414, and stop 418, respectively. To enclose main compartment 420, shelf 404 is lowered onto ledge 406 and maintained in a position on ledge 406 to thereby effect a support for computer tower chassis 102. Computer tower stand 400 is operated in the same manner as computer tower stand 100 discussed with reference to FIGS. 1-3.

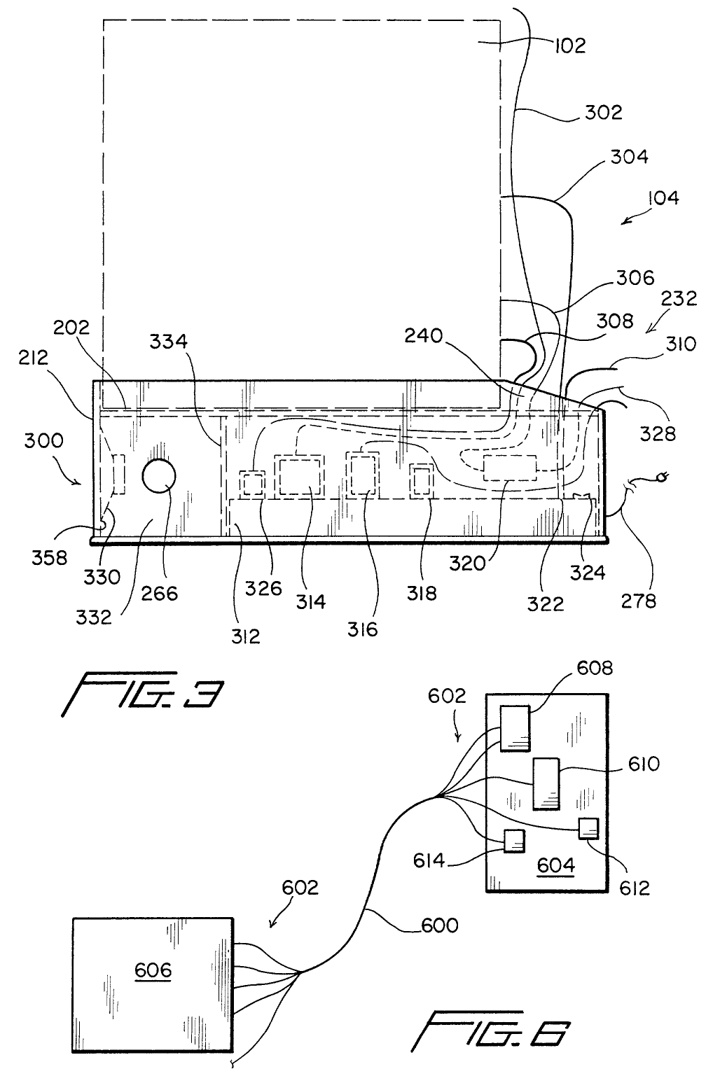

As illustrated in FIG. 5, another embodiment of a computer tower stand 500 is shown wherein a housing 502 comprises a sidewall 504 that includes a fan assembly 506 disposed therein. The fan assembly 506 is electrically connected, via an AC adapter (not shown) to an electrical device such as surge protector 312 (see FIG. 3) to provide power to the fan assembly. In this manner, the electrical devices stored within computer tower stand 500 may be cooled by a stream of air directed by fan assembly 506 into a main compartment 508 formed within housing 502. Alternatively, fan assembly 506 may be disposed in a back wall 510 of housing 502.

As may be seen from the above discussion regarding the computer tower stand and associated computer system, a multi-media computer system may include a number of peripheral cables that are included and directed towards the computer tower chassis and the computer. Therefore, in an alternative embodiment, a cable 600 is structured to receive a plurality of utility cables 602 necessary to support various computer peripheral devices including the speakers 614, keyboard 610, mouse 612, and monitor 608. The utility cables 602 may include left and right speaker wires, a USB cable, monitor signal and power cords, a mouse signal cord, a keyboard signal cord, and any other power or signal cords that are utilized with conventional computer peripheral devices that a multi-media computer system may utilize. Other computer peripheral devices incorporated into a multi-media computer system, for example, may include a scanner, printer, external DVD or CD player, external tape drive, etc. The cable 600 extends from a computer tower chassis 606 to a work area 604. The cable 600 may also extend from the computer tower stand to the computer tower chassis or directly to the individual computer devices. The excess length of the cable 600 may be stored in the computer tower stand in a manner such that the number of cords and cables 602 that are associated with the system is reduced in an effort to create a better work environment. In an alternative embodiment, a sleeve may be utilized to group the computer peripheral device utility cables together and configured to receive all of the utility cables 602 and provide organized passage of the utility cables 602 towards the rear of the computer tower chassis 606.

While the invention has been described in connection with what is presently considered to be the most practical and preferred embodiment, it is to be understood that the invention is not to be limited to the disclosed embodiments but, on the contrary, is intended to cover various modifications and equivalent arrangements included within the spirit and scope of the present invention. Thus, the present invention is to be limited solely by the appended claims.

What is claimed:

1. A computer tower stand comprising:
(a) a structure including a shelf adapted to support a computer tower chassis; and
(b) a main compartment disposed within the structure and underneath the shelf, the main compartment configured to conceal at least one cable that extends from the computer tower chassis and store electrical equipment.

2. The computer tower stand of claim 1 wherein the shelf includes at least one opening configured to provide access to the main compartment and receive the at least one cable that extends from the computer tower chassis, the opening formed in a spaced relation to the equipment to allow the at least one cable to be connected to the equipment.

3. The computer tower stand of claim 1 wherein the shelf includes a second opening configured to provide access to the main compartment and receive the electrical equipment.

4. The computer tower stand of claim 3 wherein the shelf further includes a third opening configured to provide access to the main compartment and receive the electrical equipment.

5. The computer tower stand of claim 1 wherein the main compartment further comprises at least one compartment configured to support a speaker assembly.

6. The computer tower stand of claim 5 wherein the speaker assembly includes a subwoofer.

7. The computer tower stand of claim 1 wherein the structure further includes a side rail disposed on either side of the shelf, and a stop connecting the side rails.

8. The computer tower stand of claim 1 wherein the structure further includes a front wall, a back wall, opposing side walls connecting the front and back walls, and a bottom wall wherein the main compartment is defined within the front, back, bottom, and opposing walls.

9. The computer tower stand of claim 8 wherein the shelf is removable from the opposing sidewalls.

10. The computer tower stand of claim 8 wherein a fan assembly is disposed in one of the front, back, and opposing sidewalls.

11. A computer tower stand comprising:
(a) a structure including
(1) a shelf,
(2) a front wall,
(3) a back wall, and
(4) opposing sidewalls;
(b) a main compartment defined within the shelf, front, back, and opposing sidewalls, the main compartment configured to store electrical equipment;
(c) at least one opening formed in the shelf and configured to provide access to the main compartment;
(d) a second opening formed in the shelf;
(e) a third opening formed in the shelf; and
(f) a speaker assembly compartment formed in the main compartment and configured to house a speaker assembly.

12. The computer tower stand of claim 11 wherein the shelf is configured to support a computer tower chassis.

13. The computer tower stand of claim 11 wherein the at least one opening communicates with the main compartment and is configured to receive the at least one electrical cable that extends from the back of the computer tower chassis.

14. The computer tower stand of claim 11 wherein the second opening communicates with the main compartment and is configured to receive electrical equipment therethrough.

15. The computer tower stand of claim 14 wherein the third opening communicates with the main compartment and is configured to receive electrical equipment therethrough.

16. The computer tower stand of claim 11 wherein the speaker compartment is configured to house a subwoofer assembly.

17. The computer tower stand of claim 11 wherein a fan assembly is disposed in one of a sidewall and back wall.

18. The computer tower stand of claim 13 wherein the at least one opening is formed in spatial relation to the electrical equipment stored within the main compartment such that the at least one electrical cable is connected to the electrical equipment.

19. The computer tower stand of claim 12 wherein the structure further comprises opposing side rails that extend from opposing sidewalls and a stop connecting the side rails, the side rails and the stop configured to maintain the computer tower chassis on the shelf.

20. A computer tower stand comprising:
a structure including a shelf adapted for supporting a computer tower chassis, and
a main compartment disposed underneath the shelf, the main compartment configured to support a speaker assembly therein.

21. A work environment enhancer comprising:
a cable having a length and configured to encompass a plurality of utility cables that are associated with computer peripheral devices.

22. The work environment enhancer of claim 21 wherein the utility cables include at least two of a monitor power supply cable, a monitor signal cable, speaker wire, a keyboard signal cable, a USB cable, and a mouse signal cable.

23. The work environment enhancer of claim 21 wherein the cable includes a middle section, a first end, and a second end, wherein the middle section is adapted to group the plurality of utility cables together and the first and second ends are adapted to separate the utility cables.
